(19) United States
(12) Patent Application Publication
(10) Pub. No.: US 2025/0362460 A1
(43) Pub. Date: Nov. 27, 2025

(54) DUAL LAYER OPTICAL SWITCH

(71) Applicant: NEYE SYSTEMS, INC, Emeryville, CA (US)

(72) Inventors: Ming Chiang A. Wu, Moraga, CA (US); Tae Joon Seok, El Cerrito, CA (US); Kyungmok Kwon, El Cerrito, CA (US)

(21) Appl. No.: 19/141,009

(22) PCT Filed: Dec. 20, 2023
(86) PCT No.: PCT/US2023/085236

§ 371 Date: Jun. 18, 2025

Related U.S. Application Data
(60) Provisional application No. 63/476,883, filed on Dec. 22, 2022.

(51) Int. Cl. G02B 6/35; G02B 6/12; G02B 6/136

(52) U.S. Cl. CPC G02B 6/3596; G02B 6/136; G02B 6/3546; G02B 6/356; G02B 6/3568; G02B 6/3584; G02B 2006/12061; G02B 2006/12097; G02B 2006/12145; G02B 2006/12147

(57) ABSTRACT

The present disclosure is directed to design and fabrication of the dual layer optical switching cells that controllably distribute and reroute optical signals between bus optical waveguides of an optical switch network. A dual layer optical switching cell includes one or more mechanical optical switches fabricated above a waveguide layer that includes the bus optical waveguides. An optical switch includes a suspended shunt optical waveguide supported by a metallic structure and configured to couple light from one bus optical waveguide to another bus optical waveguide when is electro-mechanically actuated. Method of fabricating such optical switched include steps that enable fabrication of optical switching cells having silicon nitride or monocrystalline silicon optical waveguides, and a metallic clamping support structure.

### INCORPORATION BY REFERENCE TO ANY PRIORITY APPLICATIONS

This application claims benefit under 35 U.S.C. § 119 (e) of U.S. Provisional Patent Application No. 63/476,883, entitled “DUAL LAYER SWITCH WITH SILICON WAVEGUIDES,” filed on Dec. 22, 2022, the content of which is hereby incorporated herein by reference in its entirety.

### BACKGROUND

### Field of the Invention

The present disclosure generally relates to optical switches used for routing optical signals in photonic systems, and more particularly to electromechanically actuated optical switching cells and optical switches.

### Description of the Related Art

Performing data processing and data transport tasks in an optical domain can significantly increase data transmission and processing rates compared to electronic systems. One of the important tasks in most computing or communication systems is controlling signal paths within a network of signal channels. A switching circuit can include reconfigurable interconnections that controllably transfer signals between different channels. Optical switching circuits that provide reconfigurable optical interconnections between a plurality of optical waveguides are important building blocks in most optical processing and communication systems and their performance advantages can have a significant impact on these systems.

### SUMMARY

In one aspect, the techniques described herein relate to an optical switching cell, including: a fixed waveguide layer fixed on a substrate, the fixed waveguide layer including: a first bus optical waveguide extending between a first optical port and a second optical port; and a second bus optical waveguide extending between a third optical port and a fourth optical port; a suspended waveguide layer suspended over the fixed waveguide layer, the suspended waveguide layer vertically separated from the fixed waveguide layer and mechanically supported by a conductive clamping structure; and the suspended waveguide layer including a shunt optical waveguide including silicon nitride or monocrystalline silicon and configured to redirect light from the first bus optical waveguide to the second optical bus waveguide, wherein when electromechanically actuated, the shunt optical waveguide optically couples a first end region thereof to the first bus optical waveguide and a second end region thereof to the second bus optical waveguide to redirect the light.

In another aspect, the techniques described herein relate to a method of fabricating an optical switch, the method including: providing a fixed waveguide layer including a first bus optical waveguide and a second bus optical waveguide fixed on a substrate; forming a sacrificial layer on the fixed waveguide layer; forming a suspended waveguide layer including monocrystalline silicon on the sacrificial layer; forming a conductive clamping structure vertically separating the fixed waveguide layer and the suspended waveguide layer; forming a shunt optical waveguide on the suspended waveguide layer configured to redirect light from the first bus optical waveguide to the second bus optical waveguide; and removing the sacrificial layer such that the suspended waveguide layer is substantially mechanically supported over the fixed waveguide layer by the conductive clamping structure, wherein when electromechanically actuated, the shunt optical waveguide optically couples a first end region thereof to the first bus optical waveguide and a second end region thereof to the second bus optical waveguide to redirect the light.

In another aspect, the techniques described herein relate to a method of fabricating an optical switch, the method including: providing a fixed waveguide layer including a first bus optical waveguide and a second bus optical waveguide fixed on a substrate; forming a sacrificial layer on the fixed waveguide layer; forming a suspended waveguide layer including silicon nitride on the sacrificial layer; forming a conductive clamping structure vertically separating the fixed waveguide layer and the suspended waveguide layer; forming a shunt optical waveguide on the suspended waveguide layer configured to redirect light from the first bus optical waveguide to the second bus optical waveguide; and removing the sacrificial layer such that the suspended waveguide layer is substantially mechanically supported over the fixed waveguide layer by the conductive clamping structure, wherein when electromechanically actuated, the shunt optical waveguide optically couples a first end region thereof to the first bus optical waveguide and a second end region thereof to the second bus optical waveguide to redirect the light.

### BRIEF DESCRIPTION OF THE DRAWINGS

FIG. 1A schematically illustrates an optical switch network comprising a plurality of optical waveguides that are controllably interconnected using a plurality of switching cells.

FIG. 1B schematically illustrates an example switching cell comprising a waveguide crossing and an optical switch.

FIGS. 1C-1D schematically illustrate cross-sectional views of a portion of the switching cell shown in FIG. 1A in a cut plane (indicated by AA′ in FIG. 1B) when the optical switch is in the OFF state (C) and ON state (D).

FIG. 1E schematically illustrates another example switching cell comprising a waveguide crossing and two optical switches.

FIGS. 2A-2D schematically illustrate cross-sectional views of intermediate structures at some of the steps in the fabrication process of the switching cell shown in FIG. 1B.

FIG. 3A schematically illustrates a cross-sectional view of an intermediate structure associated with the switching cell shown in FIG. 1B after deposition of the second waveguide layer on the sacrificial layer.

FIGS. 3B-3D schematically illustrate the fabrication steps of bonding the second waveguide layer, originally formed on a separate chip, to the sacrificial layer of an intermediate structure associated with the fabrication of the switching cell shown in FIG. 1B.

FIGS. 4A-4B schematically illustrate two cross-sectional views of an intermediate structure during the fabrication of the switching cell shown in FIG. 1B after patterning the second waveguide layer.

FIG. 4C schematically illustrates a top-down view of an intermediate structure during the fabrication of the switching cell shown in FIG. 1B after patterning the second waveguide layer.

FIGS. 4D-4E schematically illustrate two cross-sectional views of an intermediate structure during the fabrication of the switching cell shown in FIG. 1B after forming vias for fabricating the clamping support structure.

FIGS. 4F-4G schematically illustrate two cross-sectional views of an intermediate structure during fabrication of the switching cell shown in FIG. 1B after metal deposition and before removing the sacrificial layer.

FIG. 4H schematically illustrates a top-down view of an intermediate structure during the fabrication of the switching cell shown in FIG. 1B after metal deposition and before removing the sacrificial layer.

FIGS. 5A-5B schematically illustrate two cross-sectional views of the final structure of switching cell shown in FIG. 1B after removing the sacrificial layer.

FIG. 5C schematically illustrates a side cross-sectional view of the switching cell shown in FIG. 1B depicting the movement of the optical switch from the OFF state (solid line) to the ON state (dashed line).

### DETAILED DESCRIPTION

Signal operation in the optical domain can significantly increase the bandwidth and reduce loss in data processing and transport compared to operation in electrical domain. As such it can be advantageous to perform at least a portion of data processing and transport tasks required in an application, in an optical domain. One of the important tasks in any computing or communication operation, is controlling signal paths in a network of signal channels. In many applications, this task is performed by switching circuits comprising a plurality of reconfigurable interconnections among the signal channels. Optical switch networks and circuits are modules that can provide reconfigurable optical interconnection between a plurality of optical channels (e.g., optical waveguides) and can replace their electrical counterpart when data processing and transport is performed in the optical domain. Such optical switching modules may comprise a plurality of optically interconnected switching cells, each configured to control optical signal flow between at least two individual optical channels of the module. Optical switch networks and circuits can have much lower power requirements than electrical switch networks and circuits. While the insertion loss optical switches can be much smaller than their electrical counterpart, in some cases, cascade arrangement of the optical switches in an optical switch network can give rise to path-dependent optical losses that vary for different paths. Such path dependent optical loss variation can degrade the performance of the optical switch network and the corresponding optical system. Low-loss optical switches can mitigate this problem and also improve the power consumption of the system.

Some of the existing optical switch networks are implemented based on optical switch technologies and configurations that can introduce excessive optical insertion loss when connecting two optical waveguides and can be difficult and/or costly to fabricate. Moreover, some of the existing optical switches may only support optical signals having wavelengths within a limited portion of the optical spectrum (e.g., near infrared region).

This disclosure describes the structure, design, and fabrication method for optical switches and optical switching cells having lower optical insertion loss compared to existing optical switches and cells and supporting optical signals within a broad wavelength range (e.g., extending to visible wavelength region). The improved performance of the disclosed optical switches is in part a result of using methods that enable fabricating optical waveguides of an optical switching cell from materials having desired optical properties (e.g., lower absorption loss and broader transparency window). The disclosed optical switches and the corresponding optical switching cells and circuits may be used in a variety of applications including, but not limited to, communication, data centers, high performance computing (HPC), and artificial intelligence (AI) and machine learning (ML) AI/ML systems, and other applications.

The disclosed optical switches and switching cells may be fabricated using CMOS-compatible fabrication technologies. As such, in some embodiments, these optical switches and switching cells can be built directly on a silicon chip by leveraging capabilities of CMOS foundries and, in some cases, at least partially co-fabricated with CMOS devices, and electronic circuits (e.g., a control circuit that controls the optical switches) on a common chip.

In some cases, the disclosed optical switching cells (also referred to as switching cells) may be used to form a network of controllable optical interconnections between optical waveguides fabricated on a common chip or substrate. In some examples, the optical waveguides may form a matrix structure or arrangement comprising a first array of waveguides (e.g., horizontal waveguides) and a second array of waveguides (e.g., vertical waveguides) forming a matrix of waveguide crossings. In some cases, a waveguide crossing may comprise overlapping portions of a waveguide of the first array of waveguides and a waveguide of the second array of waveguides. In some cases, a waveguide crossing can be made reconfigurable using an optical switch. The reconfigurable waveguide crossing can controllably couple light propagating in one of the waveguides to the other of the waveguide of the waveguide crossing.

In some embodiments, a switching cell can be a reconfigurable optical waveguide crossing comprising at least one pair of fixed-position bus waveguides of an optical network and an optical switch comprising a movable optical waveguide portion (herein referred to as a shunt waveguide) that can be optically coupled with and decoupled from each of the bus waveguides of the pair of bus waveguides by controlled actuation (e.g., electromechanical actuation). In such cases, a first bus waveguide of the pair of the bus waveguides provides optical connection between a first and a second port of the optical network and a second bus waveguide of the pair of the bus waveguides provides optical connection between third and fourth ports of the optical network. The bus waveguides may cross each other at a crossing junction such that, when the optical switch is in its ON state, the shunt waveguide optically connects the first port to the third port and optically disconnects the first port from the second port by coupling light from the first bus waveguide to the second bus waveguide. In some embodiments, the shunt waveguide may comprise a bent (e.g., L-shape) waveguide configured to couple light from a bus waveguide to another bus waveguide via two coupling regions of the shunt waveguide. Each coupling region can be close to an end of the shunt waveguide and can be configured to couple light from a bus waveguide to the shunt waveguide when the optical switch is the ON state (e.g., upon being mechanically actuated).

Some examples of optical waveguide networks comprising switching cells having optical switches are discussed in U.S. Pat. No. 10,061,085 issued Aug. 28, 2018, which is hereby incorporated by reference herein in its entirety. It will be understood that, to the extent that any of the incorporated content may interpreted to be contradictory to corresponding content of the present disclosure, the present disclosure shall control.

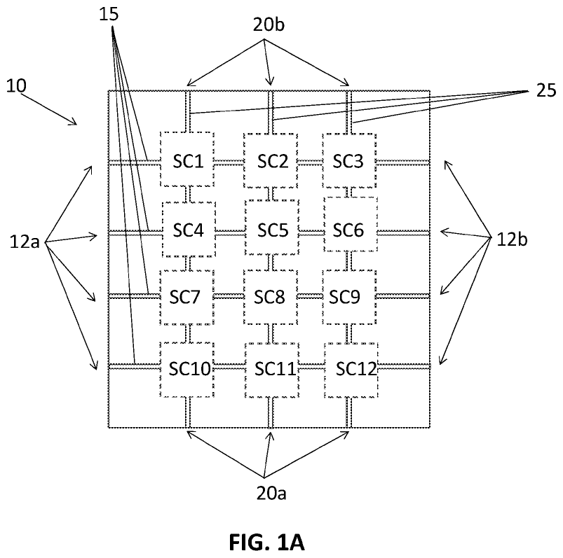

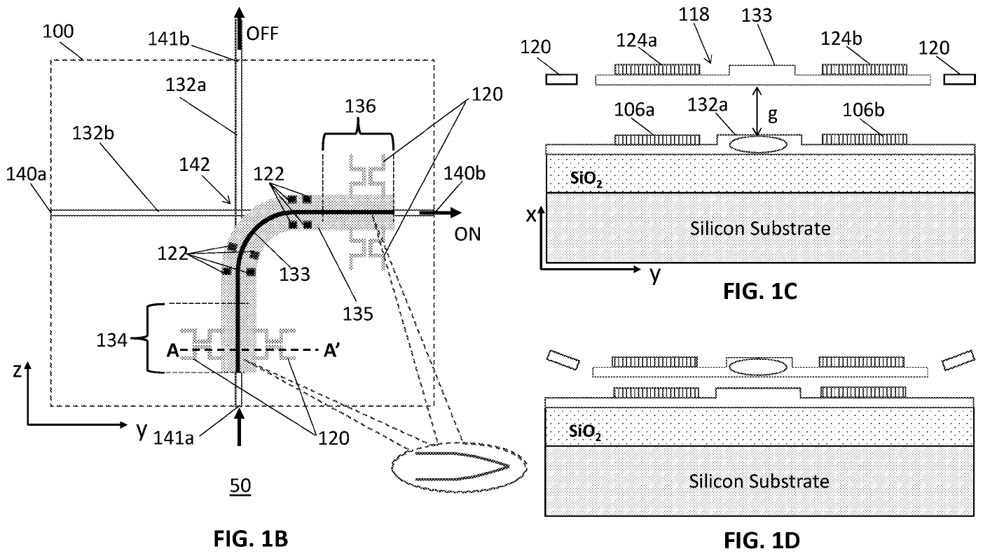

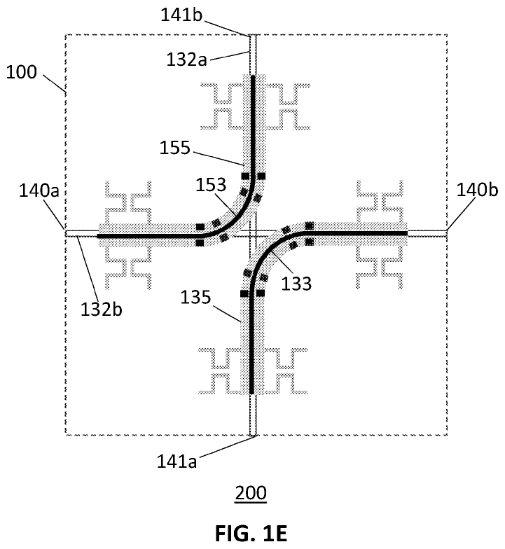

FIG. 1A schematically illustrates an example optical switch network 10 having a matrix architecture. The optical switch network 10 comprises a first plurality of optical waveguides 15 that are controllably interconnected to a second plurality of optical waveguides 25 using a matrix of switching cells (SC1, SC2, . . . . SC12). When all switching cells are in the OFF state, the first plurality of waveguides 15 optically connect a first plurality of optical ports 12a to a second plurality of optical ports 12b, and the second plurality of waveguides 25 optically connect a third of optical ports 20a to a fourth plurality of optical ports 20b.

In the example shown, the first plurality of optical waveguides 15 includes four waveguides, the second plurality of optical waveguides 25 includes three waveguides, matrix of switching cells includes twelve switching cells SC1-SC12. In some examples, each switching cell provides controllable optical coupling between an individual waveguide of the first plurality of waveguides 15 and individual waveguide of the second plurality of waveguides 25. In some examples, an individual switching cell can include at least one optical switch configured to optically couple one of the optical waveguides of the first plurality of waveguides 15 to one of the optical waveguides of the second plurality of waveguides 25. For example, when a switching cell is in the ON state an optical signal received from one port of the first plurality of optical ports 12a, may be rerouted to one port of the third plurality of optical ports 20b or vice versa, by one optical switch of the switching cell. However, when in the ON state, the same optical switch may not reroute an optical signal received from one port of the second plurality of optical ports 12b, to one port of the third plurality of optical ports 20b or of the fourth plurality of optical ports 20a. In some embodiments, an individual switching cell may comprise two optical switches configured to switchably couple one optical waveguide of the first plurality of waveguides 15 to an optical waveguide of the second plurality of waveguides 25. In some such embodiments, when both optical switches of the switching cell are in the ON state an optical signal received from one port of the first plurality of optical ports 12a, is rerouted to one port of the third plurality of optical ports 20b or vice versa, an optical signal received from one port of the second plurality of optical ports 12b is rerouted to one port of the third plurality of optical ports 20b (or vice versa) or to one port of the fourth plurality of optical ports 20a.

FIG. 1B schematically illustrates a top-down view (e.g., parallel is plane) of a portion of an optical switch network comprising an example optical switching cell (also referred to as referred to as switching cell). The switching cell 50 shown in FIG. 1B comprises a reconfigurable waveguide crossing that includes a first bus optical waveguide 132a and a second bus optical waveguide 132b which are arranged such that they cross each other at a junction (e.g., crossing region 142). In some embodiments, the bus optical waveguides (also referred to as bus waveguides) 132a, 132b are substantially orthogonal to one another. In some other embodiments, the optical waveguides 132a, 132b may not be orthogonal to one another. In the example shown, the first bus waveguide 132a optically connects a first optical port 140a to a second optical port 140b of the optical network, and the second bus waveguide 132b optically connects a third optical port 141a to a fourth optical port 141b of the optical network. In some cases, the optical ports 140a, 140b, 141a, and 141b can be arbitrary points along the respective waveguide used to separate different switching cells and therefore may not indicate an optical discontinuity along a waveguide.

In some embodiments, the intersection of the two bus waveguides 132a, 132b, herein referred to as crossing region 142, may be configured to reduce or potentially eliminate propagation of light from the first or second optical ports 140a 140b, to the third or fourth optical ports 141a, 141b, and vice versa. In some cases, the crossing region 42 may comprise a multi-mode interference region configured to prevent propagation of light between the first and the second waveguides at the crossing point, e.g., by concentrating the optical energy of the light signal near the center of the crossing region 142 as the light signal passes through it. In some of the embodiments, the bus waveguides 132a, 132b, and the multi-mode interference region can be optically coupled via flared or tapered waveguide regions that mitigate optical loss associated with propagation from a bus waveguide to the crossing region and vice versa.

The switching cell 50 may further include an optical switch 135 configured to controllably redirect or couple at least a portion of light propagating in one bus waveguide to the other bus waveguide. For example, when it is in the ON state, the optical switch 135 may redirect substantially the entire optical power received from the third optical port 141a and propagating in the first bus waveguide 132a to the second bus waveguide 132b such that an amount of optical power that passes the crossing region via the first waveguide 132a is negligible or substantially zero. For example, when it is in the ON state, the optical switch 135 may redirect more than 90%, more than 95%, more than 97%, or more than 99% of the optical power received from the third optical port 141a and propagating in the first bus waveguide 132a to the second bus waveguide 132b. In some cases, the optical switch 135 can be a structure or a patterned layer fabricated above the bus waveguides 132a, 132b and may comprise at least one waveguide portion of shunt waveguide 133 configured to guide light, and one or more electrodes (or conductive regions) configured to enable electromechanical actuation of the optical switch 135. In some cases, the optical switch 135 may comprise a slab region and a ridge (or rib) region configured to confine light in a transverse direction perpendicular to the direction of propagation of light in the corresponding shunt waveguide 133

In some embodiments the shunt waveguide 133 can be a bent optical waveguide portion extending from one end to another end of the optical switch 135. The one or more electrodes (e.g., conductive lines) can be configured to allow electromechanical actuation of at least a portion of the optical switch structure. In some cases, the shunt waveguide 133 may be a rib or ridge optical waveguide and can be at least partially embedded in the optical switch structure.

In some examples, the optical switch 135 may be at least partially suspended above the substrate 100 and supported by one or more support structures mechanically coupling or clamping at least a portion of the optical switch 135 to the substrate 100. In some cases, the support structures may comprise one or more clamping support structures 122 (also referred to as clamping structures), and one or more flexible support structures 120. The clamping support structures 122 can be configured to clamp a portion (e.g., a middle portion) of the optical switch 135 to substrate 100, and the flexible support structures 120 can be configured to allow the two end regions of the optical switch 135 to move in a vertical direction perpendicular to a main surface of the substrate 100. In some embodiments, the clamping support structures 122 can be conductive clamping structures comprising a conductive material. In some embodiments, the clamping support structures 122 may comprise one or more pillars (e.g., metallic pillars) extending from the optical switch 135 down to the substrate 100. In some cases, the clamping support structures 122 may comprise a metal such as aluminum, copper, or an alloy including aluminum, copper, and/or other metals. In some cases, the clamping support structures 122 may comprise a dielectric material. In some cases, at least a portion of the clamping support structures 122 may comprise an organic material (e.g., a polymer). In some cases, the flexible support structures 120 can mechanically connect one end of the optical switch 135 to a base structure fabricated on the substrate 100. In some examples, at least a portion of a flexible support structure 120 may comprise a folded spring structure. The flexible support structures 120 can be connected to an end of the optical switch 135 while allowing that end to bend toward the substrate 100, e.g., upon being actuated by an electrostatic force applied, at least partially, using an electrode of the optical switch 135.

In some cases, the optical switch 135 may be aligned with the bus waveguides 132a, 132b, such that the shunt waveguide 133 can controllably shunt light from one of the bus waveguides 132a, 132b, to the other to change the optical connection between the optical ports associated with these waveguides. For example, when the optical switch 135 is in the OFF state the shunt waveguide 133 is optically decoupled from the first and second bus waveguides 132a, 132b and light entering the third port 141a propagates to the fourth port 141b via the crossing region 142. When the optical switch 135 is in the ON state the shunt waveguide 133 is optically coupled to the first and second bus waveguides 132a (e.g., using electromechanical actuation), and provides an optical path that bypasses the crossing region 142 crossing region 142 and connects a portion of the first waveguide 132a to a portion of the second waveguide 132b such that light entering the third port 141a propagates to second port 140b via the shunt waveguide 133.

In some embodiments, the shunt waveguide 133 may comprise a first coupling region 134 (also referred to first end region), a second coupling region 136, and a middle region extended from the first coupling region 134 to the second coupling region 136 (also referred to second end region). The first coupling region 134 may extend from a first end of the shunt waveguide 133 to the middle region and the second coupling region 136 may extend from a second end of the shunt waveguide 133 to the middle region. The shunt waveguide 133 may be positioned above the bus waveguides 132a, 132b, such that when the optical switch 135 is in the OFF state, the first and the second coupling regions 134, 136 are vertically separated from the first and second bus waveguides 132a, 132b by first and second gap sizes, respectively, and when the optical switch 135 is in the ON state, the first and the second coupling regions 134, 136 are vertically separated from the first and second bus waveguides 132a, 132b by third and fourth gap sizes, respectively.

In some cases, the first, second, third, and fourth gap sizes each may comprise a vertical distance between a bottom surface a coupling region and a top surface of the respective bus waveguide. In some cases, the first and second gap sizes can be larger than the third and fourth gap sizes, respectively. The first and second gap sizes can be configured such that when the optical switch 135 is in the OFF state the shunt waveguide 133 is optically decoupled from the first and second bus waveguides 132a, 132b. The third and fourth gap sizes can be configured such that when the optical switch 135 is in the ON state the shunt waveguide 133 is optically coupled to the first and second bus waveguides 132a, 132b.

In some cases, the shunt waveguide 133 can be aligned with the first and second bus waveguides 132a, 132b, such that when the optical switch 135 is in the ON state the shunt waveguide is optically coupled to the first and second bus waveguides 132a, 132b via the first and second coupling regions 134, 136, respectively.

In some cases, when the optical switch 135 is in the ON state, the first and second coupling regions 134, 136, may be evanescently coupled to the first and second bus waveguides 132a, 132b.

In a preferred embodiment, when the optical switch 135 is in the ON state, at least a portion of each of the first and second coupling regions 134, 136, are positioned immediately adjacent, but not in contact with, the first and second bus waveguides 132a, 132b. In some other embodiments, when the optical switch 135 is in the ON state, at least a portion of each of the first and second coupling regions 134, 136, can be contact with the first and second bus waveguides 132a, 132b.

In some cases, when the optical switch 135 is in the ON state, the first coupling region 134 and the first bus waveguide 132a may form a first optical directional coupler, and the second coupling region 136 and the second bus waveguide 132b may form a second optical directional coupler. In some embodiments, the first and the second directional couplers may be configured to couple a specified portion of light propagating in one of the bus waveguides 132a, 132b, to the shunt waveguide 133 and vice versa. In some cases, the specified portion can be from 1% to 5%, from 5% to 10%, from 10% to 30%, from 30% to 50%, 50% to 70%, from 50% to 70%, from 70% to 90%, from 90% to 95%, from 95% to 99%, or larger values. In some cases, one of the first or second directional couplers may be configured to couple nearly 100% (e.g., more than 98%), and the other directional may be configured to couple a specified portion within one of the ranges listed above, of light propagating in one of the bus waveguides 132a, 132b to the shunt waveguide 133 (and vice versa.

In some cases, when the optical switch 135 is in the ON state, a specified portion of light received from the third optical port 141a and propagating in the first bus waveguide 132a may be transmitted to the second bus waveguide via the shunt waveguide 133, and vice versa. In some cases, the specified portion can be from 50% to 70%, from 70% to 90%, from 90% to 95%, from 95% to 99%, or larger values.

In some cases, when the optical switch 135 is in the OFF state, a portion of light coupled from the first bus waveguide 132a to the second bus waveguide 132b may not exceed 3%, 2%, 1%, 0.1%, 0.01%, or smaller values.

In some cases, a gap between a bus waveguide and the respective coupling region of the shunt waveguide 133, may be tunable using an actuation mechanism. In some examples, the actuation mechanism may comprise a micro-electromechanical system (or MEMS structure where a controllable electrostatic force moves the coupling region toward the bus waveguide and reduces the coupling gap. The actuator implemented may include, without limitation, electrothermal, thermal, magnetic, electromagnetic, electrostatic combdrive, magnetostrictive, piezoelectric, fluidic, pneumatic actuators, and the like. As such the strength of optical coupling between each one of the coupling regions 134, 136 of the shunt waveguide 133 and the respective bus waveguide, may be controlled by electric actuation. In some embodiments, the electrostatic force may be generated and controlled by generating an electric potential difference between a region (e.g., a conductive region) of the optical switch 135 and the substrate 100 (e.g., a conductive region of the substrate). In these embodiments, the coupling gaps, and thereby optical couplings, between the coupling regions 134, 136, and the respective one of the bus waveguides 132a, 132b may be controlled or tuned by adjusting a potential difference between the corresponding portions of the optical switch 135 and the substrate 100. For example, the state of the optical switch 135 may be changes from the OFF state to the ON state, by providing potential differences between the end portions of the optical switch 135 and the substrate 100 such the first gap size changes to the third gap size and second gap size changes to the fourth gap size. In some examples, the potential difference may be provided by a voltage source electrically connected to the conductive regions of the optical switch 135 and the substrate 100 (e.g., via conductive lines disposed on the substrate 100).

In some cases, at least one coupling regions 134, 136, of the shunt waveguide 133 may include a tapered region having a width that is tapered toward an end of the shunt waveguide 133. In some examples, when a coupling region having a tapered region is actuated and bends toward the respective bus waveguide, an adiabatic optical coupler may be formed by the coupling region and the bus waveguide allowing low loss adiabatic transfer of optical power from the bus waveguide to the shunt waveguide 133 and vice versa.

Examples of waveguide crossing regions having a multi-mode interference region and shunt waveguides having a tapered coupling regions are discussed in U.S. Pat. No. 10,061,085 issued Aug. 28, 2018, which is hereby incorporated by reference herein in its entirety. It will be understood that, to the extent that any of the incorporated content may interpreted to be contradictory to corresponding content of the present disclosure, the present disclosure shall control.

FIG. 1C-1D schematically illustrate cross-sectional views of a portion of the switching cell shown in FIG. 1B in a cut plane (indicated by AA' in FIG. 1B) perpendicular to a main surface of the substrate 100 (e.g., parallel to x-axis). In FIG. IC the optical switch 135 is in the OFF state and the vertical gap size g between the shunt waveguide 133 and the bus waveguide 132a below the shunt waveguide 133, is large enough to prevent optical coupling between the shunt waveguide 133 and the bus waveguide 132a. In some cases, in the OFF state an electric potential difference between second top electrode portions (e.g., top conductive lines 124a, 124b) of the optical switch 135 and electrodes (e.g., bottom conductive lines 106a, 106b) on the substrate 100 can be substantially zero. In some cases, in the OFF state the vertical gap size g can be from 0.1 microns to 0.5 microns, form 0.5 microns to 1 micron, 1 micron to 2 microns, 2 microns to 3 microns, 3 microns to 4 microns, or larger values.

In FIG. 1D the optical switch 135 is actuated and is in the ON state. In some cases, the optical switch 135 is actuated, e.g., by generating an electric potential difference between the top conductive lines 124a, 124b of the optical switch 135 and the bottom conductive lines 106a, 106b on the substrate 100. In some examples, when optical switch is actuated a portion of the optical switch suspended over the first optical waveguide 132a (e.g., a portion comprising the coupling region 134) may bend down toward the bus waveguide to reduce vertical gap size g between the coupling region 134 of the shunt waveguide 133 and the bus waveguide 132a and optically couple the shunt waveguide 133 with the bus waveguide 132a. In some cases, in the ON state the vertical gap size g can be from 0.5 micron to 0.3 micron, from 0.3 micron to 0.2 micron, from 0.2 micron to 0.1 micron, from 0.1 micron to 0.05 micron, or smaller values.

FIG. 1E schematically illustrates an example switching cell 200 comprising a waveguide crossing and two optical switches. For example, the switching cell 200 may comprise a second optical switch 155 having a second shunt waveguide 153, in addition to the optical switch 135, such that each one of the optical switches 135, 155, optically couple different portions of the first and second waveguides 132a, 132b. The second optical switch 155 may comprise one or more features described above with respect to the optical switch 135. In this example, the switching cell 200 can provide a controllable optical path from the third optical port 141a to the second optical port 140b and a controllable optical path from the first optical port 141a to the fourth optical port 141b. When both optical switches 135, 155, of the switching cell 200 are in the ON state, the third optical port 141a is bidirectionally connected to the second optical port 140b, and the first optical port 140a is bidirectionally connected to the fourth optical port 141b.

In some embodiments, the switching cell 50 shown in FIG. 1B may fabricated on a silicon substrate using CMOS compatible fabrication methods and processes. Some embodiments and methods described below provide nonlimiting examples of fabrication steps and structural properties (e.g., geometrical and material properties) of a switching cell comprising at least one shunt waveguide controllably coupled to two bus waveguides. Advantageously, the disclosed fabrication steps enable fabricating bus waveguides and shunt waveguides having lower optical loss (e.g., insertion loss) in visible and/or near infrared wavelength ranges, compared to bus waveguides and shunt waveguides used in existing switching cells. In some examples, the disclosed switching cells can include bus waveguides and shunt waveguides comprising single crystal silicon (also referred to as monocrystalline silicon) and silicon nitride. In some embodiments, the optical propagation loss in the bus and shunt optical waveguides of the switching cells described below can be less than 1 dB/cm, less than 0.5 dB/cm, less than 0.1 dB/cm, less than 0.01 dB/cm, or smaller values for light having a wavelength within an operational wavelength range of the switching cell. In some cases, the operational wavelength range of the switching cell, can be from 400 nm to 1100 nm to 1200 nm, from 1200 nm to 1400 nm, 1400 nm to 1500 nm, from 1500 nm to 1600 nm, from 1260 to 1360 nm, from 1450 to 1650nm or any ranges within ranges formed by these values or larger or smaller values.

In some embodiments, the bus waveguides are fabricated in as first layer and the shunt waveguide is fabricated as a second layer above the first layer using a sacrificial layer as a spacer. In some examples, the sacrificial layer may comprise an organic material so that it can be removed without affecting the structural properties (e.g., surface roughness) of the substrate, bus waveguides, and the shut waveguide. Additionally, the disclosed fabrication methods may allow fabricating optical switches connected to the substrate by metallic clamping support structures (e.g., metallic pillars or vias).

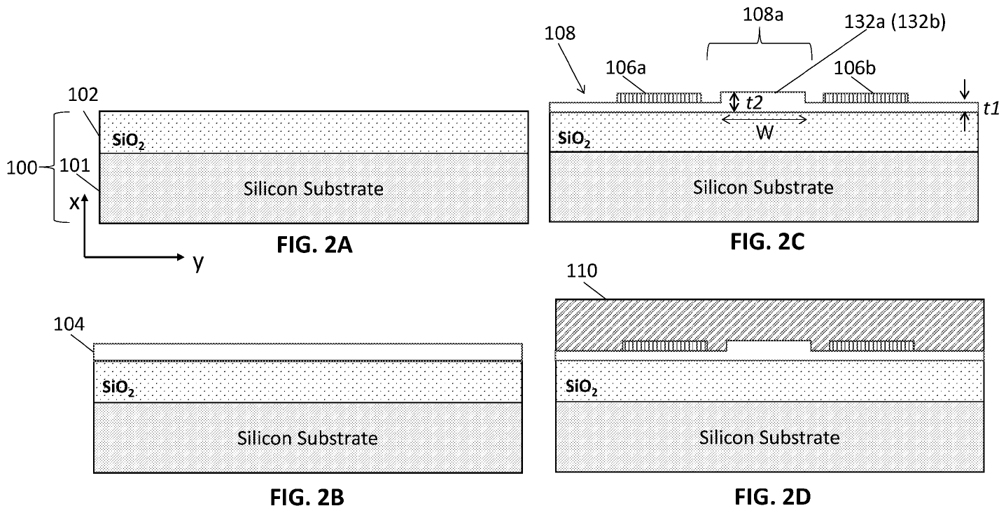

FIGS. 2A-2D schematically illustrate cross-sectional views of intermediate structures at some of the steps in the fabrication process a switching cell (e.g., switching cell 50) that includes a mechanically actuated optical switch (e.g., optical switch 135). In some cases, the fabrication process may comprise fabrication of at least two optical waveguides (e.g., optical waveguides 132a and 132b) on a layered substrate (e.g., substrate 50) and a shunt waveguide (e.g., shunt waveguide 133) that is positioned above the optical waveguides and it is at least partially movable with respect to the substrate.

In some embodiments, the fabrication process may begin by providing a substrate 100 (a layered substrate) comprising a silicon substrate 101 having a dielectric layer 102 (e.g., a base dielectric layer) on one of its main surfaces (e.g., top surface). In some cases, the dielectric layer 102 may comprise a silicon dioxide (SiO2) layer. In some examples, the silicon dioxide layer can be a thermally grown or deposited silicon dioxide layer. FIG. 2A shows a cross-sectional view of the substrate 100 (e.g., a layered substrate).

In some embodiments, a thickness of the dielectric layer 102 along a vertical direction perpendicular to a main surface of the silicon (Si) substrate 101 (e.g., along x-axis) can be from 1 micron to 1.5 micron, from 1.5 to 2 microns, from 2 to 3 microns, from 3 to 4 microns, from 4 to 5 microns, from 5 to 6 microns, or larger values.

The fabrication step shown in FIG. 2B may comprise depositing a first waveguide layer 104 on a surface of the dielectric layer 102 opposite to the Si substrate 101 (e.g., the top surface of the SiO2 layer 102). In some embodiments, the first waveguide layer 104 may comprise a silicon (Si) or a silicon nitride (SiN) layer. In some examples, the silicon layer may comprise a single crystal Si layer, polysilicon layer, or an amorphous Si layer. In various implementations the Si layer may be grown, deposited, or bonded on the SiO2 layer. In some examples, the SiN may be deposited on the SiO2 102 layer (e.g., using chemical vapor deposition, CVD, hot filament chemical vapor deposition, plasma enhanced chemical vapor deposition, PECVD, low-pressure chemical vapor deposition LPCVD, or other methods).

In some embodiments, a thickness of the first waveguide layer 104 along a vertical direction perpendicular to a main surface of the Si substrate 101 (e.g., along x-axis) can be from 0.1 to 0.2 micron, from 0.2 to 0.3 micron, from 0.3 to 0.5 micron, from 0.5 to 1 micron, from 1 micron to 1.5 microns, from 1.5 to 2 microns, or any ranges formed by these values or larger or smaller values.

The fabrication step shown in FIG. 2C may comprise patterning the first waveguide layer 104 to form one or more bus optical waveguides (e.g., bus waveguides 132a, 132b) followed by depositing and patterning a conductive layer to form at least one electrode (e.g., a conductive region) on the patterned waveguide layer 108 (also referred to as fixed waveguide layer). In some cases, the patterned waveguide layer 108 may comprise an optical switch (e.g., the optical switch 135). In some such cases, the patterned waveguide layer 108 may comprise at least apportion of a flexible and/or a clamping support structure (e.g., a portion of the flexible support structures 120). In some examples, the electrode (also referred to as bottom electrode or immovable electrode) may serve as a bottom actuation electrode for the optical switch. In some cases, fabrication of a bus optical waveguide may comprise photolithographically patterning a photoresist layer on the first waveguide layer 104 and etching the exposed regions of the waveguide layer (regions not covered by a cured photoresist layer) to form a waveguide region 108a of the patterned waveguide layer 108. In some examples, the waveguide region 108a may comprise a rib (or ridge) waveguide portion. In some such cases, the bus optical waveguide (e.g., bus waveguide 132a or 132b) may comprise a rib (or ridge) optical waveguide. The waveguide region 108a may confine optical field in the lateral (e.g., along y-axis) and vertical (e.g., along x-axis) directions and allow propagation of the confined optical field in a direction (e.g., along the z-axis) perpendicular to the lateral and vertical directions. In some examples, the waveguide region 108a can be a region where most of the optical energy is confined (e.g., more than 90% or more than 95% of the optical energy). In some cases, the width of the waveguide region 108a can be larger than the actual width of the bus waveguide 132a (or 132b) that may be defined by the width of the ridge or rib portion of the patterned waveguide layer 108.

In some examples, such as the example shown in FIG. 2C, fabrication of the at least one electrode may comprise depositing a conductive layer on the patterned waveguide layer 108, photolithographically patterning a photoresist layer on the conductive layer, and etching the exposed regions of the conductive layer to form the electrode. In some cases, the at least one electrode may comprise two bottom conductive lines 106a, 106b formed on opposite sides of the waveguide region 108a. In some cases, when the waveguide region 108a is a ridge waveguide, the patterned waveguide layer 108 may not cover portions of the SiO2 layer 108 outside of the waveguide region 108a. In some such cases, two bottom conductive lines 106a, 106b may be disposed on and be in contact with the SiO2 layer.

In some embodiments, the at least one electrode (the at least one bottom electrode) may comprise a conductive region formed on the patterned waveguide layer 108 by increasing the conductivity of a region of the patterned waveguide layer 108. In some cases, instead of metal deposition, such conductive region may be formed by doping the patterned waveguide layer 108 via thermal diffusion, ion implantation or other methods. In some examples, the at least one electrode may comprise two longitudinally extending conductive regions formed on opposite sides of the waveguide region 108a.

In some embodiments, a thickness of the conductive layer and the bottom conductive lines 106a, 106b along a vertical direction perpendicular to a main surface of the Si substrate 101 (e.g., along x-axis) can be from 0.1 to 0.5 micron, from 0.5 to 1 micron or any ranges formed by these values or larger or smaller values.

In some embodiments, the geometrical dimensions of the waveguide region 108a (e.g., the widths and thickness of the rib or ridge waveguide region 108a) may be configured to support the propagation of a single optical mode (e.g., single transverse optical mode) in the waveguide region 108a at a wavelength within a specified wavelength range (e.g., a wavelength range suitable for optical communication). In some cases, the single optical mode can be a transverse electric (TE) mode of the waveguide region 108a (the bus waveguide 132a or 132b). In some examples, a thickness t2 of the rib (or ridge) portion of the waveguide region 108a can be from 0.1 to 0.2 micron, from 0.2 to 0.3 micron, from 0.3 to 0.5 micron, from 0.5 to 1 micron, from 1 micron to 1.5 microns, from 1.5 to 2 microns, or any ranges formed by these values or larger values. In some examples, a thickness t1 of the patterned waveguide layer 108 outside of the rib (or ridge) portion of the waveguide region 108a (also referred to as slab portion) can be from 0.05 to 0.1 micron, 0.1 to 0.15 micron, 0.15 to 0.2 micron, 0.2 to 0.3 micron, 0.3 to 0.5 micron or larger values.

In some examples, two or more bus optical waveguides of an optical waveguide network may be co-fabricated by patterning the first waveguide layer 104. In some cases, the two more bus optical waveguides may include at least two waveguides crossing each other at a junction. For example, bus waveguides 132a and 132b and the corresponding electrodes may be co-fabricated in the fabrication step shown in FIG. 2C. As such the cross-section shown in FIG. 2C may represent an intermediate structure along the AA′ cut plane including bus waveguide 132a or an intermediate structure along the BB′ cut plane including bus waveguide 132b.

In the fabrication step shown in FIG. 2D, a sacrificial layer 110 may be disposed on the patterned waveguide layer 108 and the at least one electrode (e.g., the bottom conductive lines 106a, 106b). In some cases, the sacrificial layer 110 may comprise an inorganic material (e.g., SiO2). In some cases, the sacrificial layer 110 can be an organic sacrificial layer comprising an organic material such as polymer (e.g., a photoresist material, e.g., SU-8, polyimide). In various implementations, the sacrificial layer 110 may be disposed by a polymer deposition process, lamination, bonding, spin coating, or other methods. In some examples, the sacrificial layer 110 may comprise a material that can be removed by an etching process that does not substantially affect the surrounding layers and structures upon completion of the mechanical optical switch. In some cases, the etching process may comprise wet etching using a solvent or dry etching using oxygen plasma. As such, in some cases, the composition of the sacrificial layer 110 may be determined, based at least in part, on the composition and properties of the first waveguide layer 104, the dielectric layer 102, and a second waveguide layer described below.

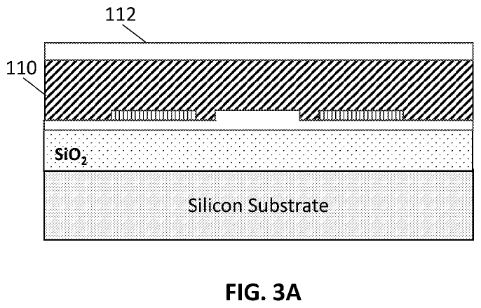

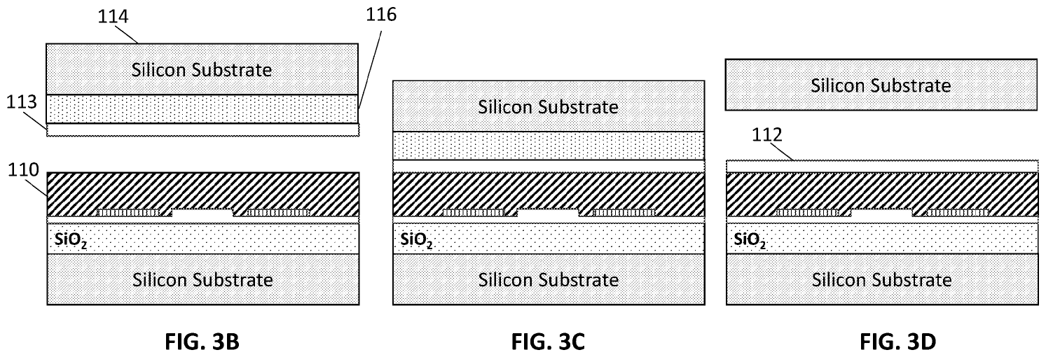

FIG. 3A and FIGS. 3B-D illustrate different fabrication steps that may follow the fabrication step shown in FIG. 2D to dispose a second waveguide layer 112 on the sacrificial layer 110. In some cases, the second waveguide layer may comprise silicon (Si), silicon nitride (SiN) layer. In some cases, the SiN layer may comprise stoichiometric nitride, low stress nitride, or other types. In some examples, the Si layer may comprise a single crystal Si (also referred to as monocrystalline silicon). In some other examples, the Si layer may comprise a polysilicon or amorphous Si. In some examples, the composition of the second waveguide layer 112 can be identical to that of the first waveguide layer 104. For example, both first and second waveguide layers 104, 112, can be silicon nitride layers. In some cases, the thickness of the second waveguide layer 112 can be substantially equal to the thickness of the first waveguide layer 104. In some other cases, the thickness of the second waveguide layer 112 can be different from that of the first waveguide layer 104.

In the fabrication step shown in FIG. 3A, the second waveguide layer 112 is deposited or grown on the sacrificial layer 110. For example, the second waveguide layer 112 may comprise SiN deposited using chemical vapor deposition, CVD, hot filament chemical vapor deposition, plasma enhanced chemical vapor deposition, PECVD, low-pressure chemical vapor deposition LPCVD, or other methods.

In some embodiments, the second waveguide layer 112 can be fabricated separately and then bonded on the sacrificial layer using flip-chip bonding. In the fabrication steps shown in FIG. 3B-3D, the second waveguide layer 112 can be a single crystal Si layer 113 transferred from a silicon-on-insulator (SOI) wafer (also referred to as donor substrate) and bonded to the sacrificial layer 110. In the example shown in FIG. 3B, the SOI wafer is a layered substrate comprising a Si substrate 114, a SiO2 layer 116, and the single crystal Si layer 113. In some examples, the thickness of the single crystal Si layer 113 can be 0.1 to 0.2 micron, 0.2 to 0.3 micron, from 0.3 to 0.5 micron, or from 0.5 to 1 micron. In the fabrication step shown in FIG. 3C the main surface of the Si layer 113 of the SOI wafer is brought into contact with the main surface (e.g., top surface) of the sacrificial layer 110 to form a bond (e.g., by thermal bonding). In the fabrication step shown in FIG. 3D the Si substrate 114 is separated from the bonded Si layer 113, which is bonded to the sacrificial layer 110, e.g., by grinding of the Si substrate 114 followed by wet etching of the SiO2 layer 116, or, in some cases, by wet etching of SiO2 layer 116. As such, Si layer 113 is transferred on top of the sacrificial layer 110 and serves as the second waveguide layer 112.

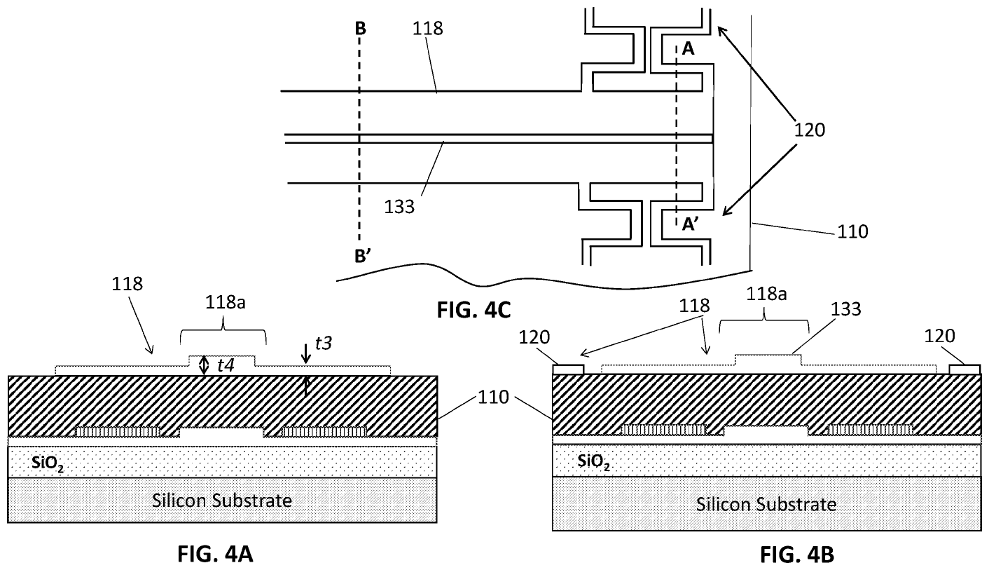

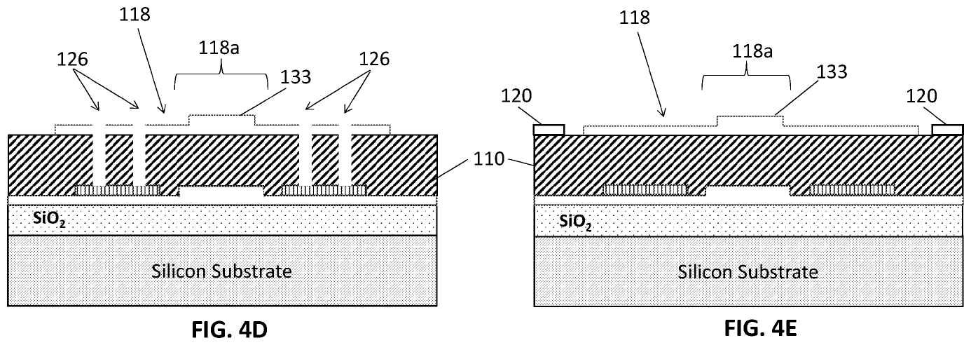

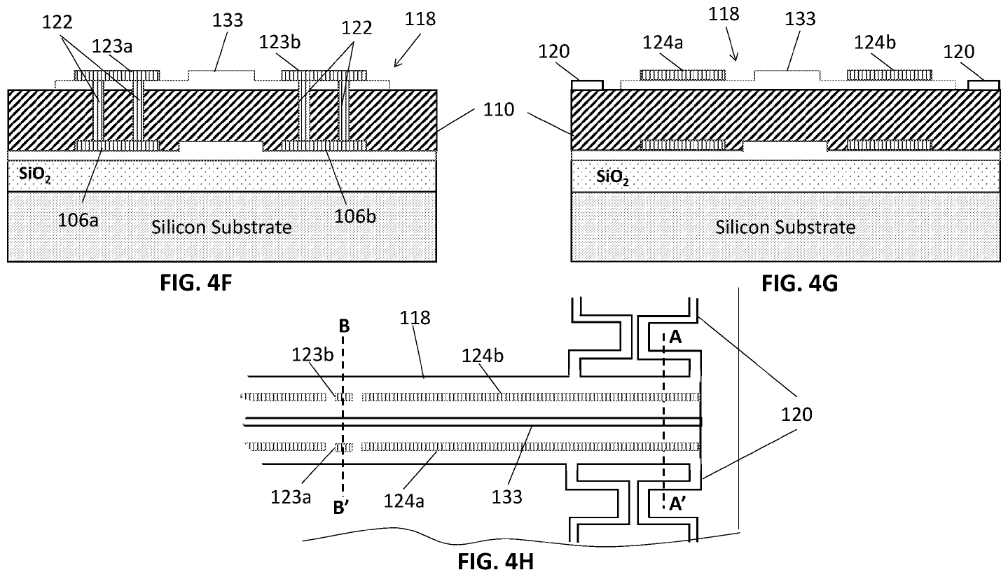

In the fabrication step shown in FIGS. 4A-4B the second waveguide layer 112 may be patterned to form the shunt waveguide 133 and, in some cases, structures that support the shunt waveguide 133 (e.g., flexible support structures 120) on sacrificial layer 110. FIGS. 4A and 4B show vertical cross-sections of portions of the fabricated layered structure in the B-B′ cut plane away from the coupling ends, and in the A-A′ cut plane near a coupling end of the shunt waveguide 133, respectively. FIG. 4C shows a top-down view of a portion of the second pattered waveguide layer 118 (also referred to as suspended waveguide layer) comprising a second waveguide region 118a and the support structures 120. The second patterned waveguide layer 118 may comprise at least a portion of an optical switch (e.g., the optical switch 135). The second waveguide region 118a may comprise the shunt waveguide 133 and, in some cases, the support structures 120. The flexible support structures 120 can be configured to movably support the coupling regions 134, 136 of the shunt waveguide 133 (as shown in FIG. 1A). In some examples, the second waveguide region 118a can be a region where most of the optical energy is confined (e.g., more than 90% or more than 95% of the optical energy). In some cases, the width of the second waveguide region 118a can be larger than the actual width of the shunt waveguide 133, which may be defined by the width of the ridge or rib portion of the second patterned waveguide layer 118. In some embodiments, the flexible support structures 120 can be fabricated separate from the shunt optical waveguide 133 and may comprise a material different from that of the second patterned waveguide layer 118. In some cases, at least a portion of the flexible support structure 120 can be fabricated before or after patterning the second waveguide layer 112.

In some cases, fabrication of a bus optical waveguide may comprise photolithographically patterning a photoresist layer on the second waveguide layer 112 and etching the exposed regions of the waveguide layer (regions not covered by a cured photoresist layer) to form a waveguide region 118a of the patterned waveguide layer 112. In some such cases, the second waveguide region 118a comprises the shunt waveguide 133. In some examples, the second waveguide region 118a may comprise a rib (or ridge) waveguide portion. In some such cases, the shunt optical waveguide 133 comprises a rib (or ridge) optical waveguide. The second waveguide region 118a may confine optical field in the lateral (e.g., along y-axis) and vertical (e.g., along x-axis) directions, and allow propagation of the confined optical field in a direction (e.g., along the z-axis) perpendicular to the lateral and vertical directions.

In some embodiments, the geometrical dimensions of the second waveguide region 118a (e.g., the widths and thickness of the rib or ridge waveguide region 118a) may be configured to support the propagation of a single optical mode (e.g., single transverse optical mode) in the second waveguide region 118a at a wavelength within a specified wavelength range (e.g., a wavelength range suitable for optical communication). In some cases, the single optical mode can be a transverse electric (TE) mode of the second waveguide region 118a (the shunt waveguide 133). In some examples, a thickness t4 of the rib (or ridge) portion of the second waveguide region 118a can be from 0.1 to 0.2 micron, from 0.2 to 0.3 micron, from 0.3 to 0.5 micron, from 0.5 to 1 micron, from 1 micron to 1.5 microns, from 1.5 to 2 microns, or any ranges formed by these values or larger values. In some examples, a thickness t3 of the second patterned waveguide layer 118 outside of the rid (or ridge) portion of the second waveguide region 118a (also referred to as second slab portion) can be from 0.05 to 0.1 micron, 0.1 to 0.15 micron, 0.15 to 0.2 micron, 0.2 to 0.3 micron, 0.3 to 0.5 micron, or larger values.

In some embodiments, a thickness of the sacrificial layer 110 layer along a vertical direction perpendicular to a main surface of the Si substrate 101 (e.g., along x-axis) can be from 0.1 to 0.5 micron, from 0.5 to 1 micron, from 1 micron to 2 microns, from 2 microns to 3 microns, from 3 microns to 4 microns, or any range formed by these values or larger values. In some cases, the thickness of the sacrificial layer 110 may be determined based at least in part on compositions of the first and second waveguide layers 104, 112, and the geometrical properties of the corresponding waveguide regions 108a, 118a to provide a desired optical coupling strength (e.g., optical coupling coefficient) between the waveguide regions 108a, 118a when the shunt waveguide is in the ON and OFF states.

In the fabrication step shown in FIGS. 4D-4E one or more through vias 126 may be formed at a region away from the two ends of the second waveguide region 118a (e.g., coupling regions 134, or 136 of the shunt waveguide 133) where clamping support structures (e.g., clamping support structures 122) may be formed to clamp a region (e.g., a middle region) of the second patterned waveguide layer 118. In some cases, the vias may extend from a top surface of the second patterned waveguide layer 118 to a top surface of a conductive line (e.g., bottom conductive lines 106a, 106b) fabricated on the first patterned waveguide layer 108. FIG. 4D shows a vertical cross-section of a portion of the fabricated layered structure in the B-B′ cut plane (as shown in FIG. 4H) where a pair of vias 126 are formed above each conductive line. FIG. 4E shows a vertical cross-section of a portion of the fabricated layered structure in the A-A′ cut plane (as shown in FIG. 4H) near an end of waveguide region 118a (e.g., coupling region 134, or 136 of the shunt waveguide 133) where no vias is formed.

In the fabrication step shown in FIGS. 4F-4G the vias 126 are filled with a filler material to form the clamping support structures 122 and, in some cases, a conductive layer is disposed and patterned on the second patterned waveguide layer 118 to form one or more electrodes (referred to as top electrodes). The second patterned conductive layer may comprise at least a first top electrode portion (e.g., electrode portions 123a, 123b) on the second patterned waveguide layer 118 above the clamping support structure. In some cases, the first top electrode portion may comprise planar metallic layers or regions. In some cases, the vias may be filled with a conductive material. In some cases, the conductive material used to form the clamping support structures 122 can be substantially the same conductive material used to form the second patterned conductive layer. In some cases, the conductive material used to form the clamping support structures 122 can be different from the conductive material used to form the second conductive layer. In some cases, the conductive material may include aluminum, copper, gold, tungsten, or an alloy comprising one or more of these metals or other metals. In some cases, the vias may be filled with a non-conductive material (e.g., a dielectric, an organic material). In some examples, the clamping support structures 122 may comprise two or more conductive pillars or conductive vias (e.g., metallic pillars) extending from the first top electrode portions to the bottom electrodes.

The second patterned conductive layer may further comprise at least a second top electrode portion on the second patterned waveguide layer 118. The second top electrode portion (e.g., top conductive lines 124a, 124b) may extend from the first top electrode portion to a coupling end of the shunt waveguide 133. In some embodiments the first and second top electrode portions may be electrically isolated to allow a voltage difference between the second top electrode portions and a bottom electrode (e.g., the bottom conductive lines 106a, 106b). In some cases, the first top electrode portion is not electrically connected to any circuitry.

In some embodiments, the second top electrode portion may comprise a conductive region formed on second patterned waveguide layer 118 by increasing the conductivity of a region of second patterned waveguide layer 118. In some cases, such conductive region may be formed by doping second patterned waveguide layer 118 via thermal diffusion, ion implantation or other methods.

In various implementations, the first and second top electrode portions may have any geometrical shapes including but not limited to rectangle, square, circle, oval, and the like.

FIG. 4F shows a vertical cross-section of a portion of the fabricated layered structure in the B-B′ cut plane (as shown in FIG. 4H) away from the coupling ends depicting first top electrode portions 123a, 123b and the clamping support structures 122 comprising conductive (e.g., metallic) pillars in contact the first top electrode portions 123a, 123b and the bottom conductive lines 106a, 106b. FIG. 4G shows a vertical cross-section of a portion of the fabricated layered structure in the A-A′ cut plane (as shown in FIG. 4H) near a coupling end of the shunt waveguide 133 depicting the second electrode portions that, in this case, comprise two top conductive lines 124a, 124b extending from the first top electrode portions 123a, 123b to an end of the second patterned waveguide layer 118 (e.g., along a coupling region of the shunt waveguide 133). In the example shown, the first top electrode portions 123a, 123b and the top conductive lines 124a, 124b (second top electrode portions) are separated by two insulating gaps, each between one of the first top electrode portion (123a or 123b) and the top conductive lines (124a or 124b). In some embodiments, instead of a metal layer, the second top electrode portions may comprise two doped conductive regions, formed in the second pattered waveguide layer 118, extending the first top electrode portions 123a, 123b a coupling end of the shunt waveguide 133.

FIG. 4H shows a top-down schematic view of a portion of the second pattered waveguide layer 118 comprising the shunt waveguide, and the second patterned conductive layer comprising the first top electrode portions 123a, 123b and the second top electrode portions (top conductive lines 124a, 124b).

In some embodiments, the first top electrode portions 123a, 123b, and the clamping support structures 122 are not electrically connected to any circuitry. In some embodiments, the first top electrode portions 123a, 123b, and the clamping support structures 122 are electrically isolated from the top conductive lines 124a, 124b.

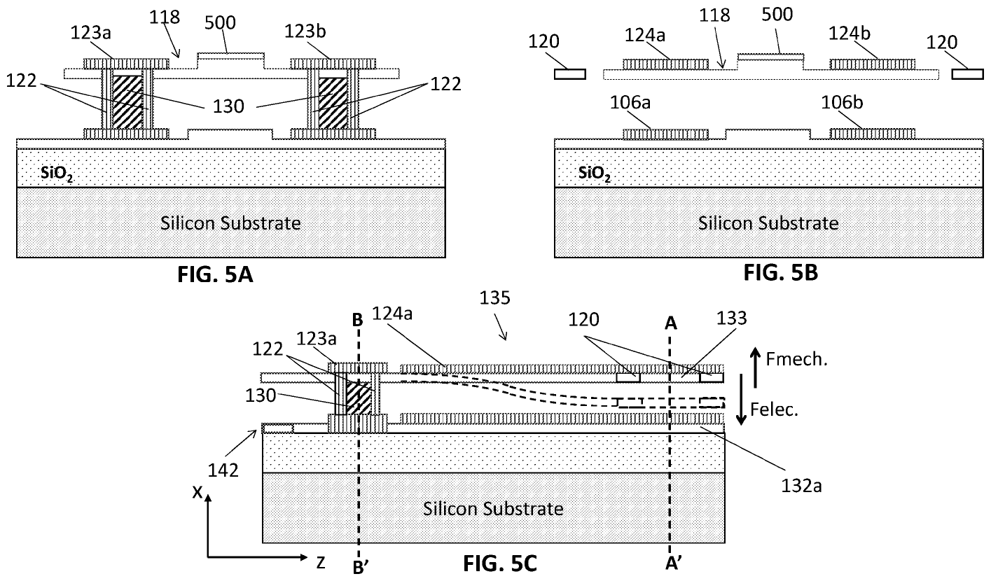

In the fabrication step shown in FIGS. 5A-5B, the sacrificial layer 110 is at least partially removed to suspend an unclamped portion of the second patterned waveguide layer 118 and form the optical switch (the optical switch 135). In various implementations the sacrificial layer 110 (e.g., an organic sacrificial layer) may be revied by a dry etching process.

In some cases, the dry etching process may comprise oxygen plasma etching or another process comprising oxidizing an organic material. In some cases, removing the sacrificial layer 110 provide an air gap least below a longitudinal portion of the second patterned waveguide layer 118 corresponding to the coupling regions 134, 136 of the shunt waveguide 133 to allow the coupling regions 134, 136 to move toward the bus waveguides 132a and 132b, and to become optically coupled to the respective bus waveguides 132a and 132b, e.g., when a potential difference is provided between the top conductive lines 124a, 124b and the bottom conductive lines 106a, 106b. In some cases, the removal (e.g., etching) process may be controlled such that a portion of the sacrificial layer 110 near the clamping support structures remains between the first and second patterned waveguide layers 108 and 118. In some cases, the remaining portion of the sacrificial layer 110 may provide additional support for the clamped portion of the second patterned waveguide layer 118. FIG. 5A shows a vertical cross-section of a portion of the fabricated layered structure in the B-B′ cut plane away from the coupling after the sacrificial layer 110 removal process. As shown in FIG. 5A a portion 130 of the sacrificial layer is remained within the clamping support structures 122. As such, in some cases, clamping support structures 122 may comprise a hybrid structure comprising a metallic region (e.g., conductive pillars or vias) and a non-conductive (e.g., polymeric) region. In some cases, the non-conductive region of the clamping support structures 122 may mechanically reinforce the conductive region). FIG. 5B shows a vertical cross-section of a portion of the fabricated layered structure in the A-A′ cut plane near a coupling end of the shunt waveguide 133, where sacrificial layer 110 is completely removed to suspend a coupling region (e.g., coupling region 134 or 136) of the shunt waveguide 133. The flexible support structure 120 partially supports the corresponding coupling region of the shunt waveguide 133 and when the state of optical switch is changed from the ON to OFF state, helps the bent coupling region of the shunt waveguide 133 to go back to its neutral position and optically decouple from the bus waveguide.

In some embodiments, a cladding layer may be disposed on the shunt waveguide 133, e.g., after the fabrication step shown in FIGS. 4A-4B to adjust an effective refractive index of the shunt waveguide 133 (e.g., the effective index of the widest portion of the shunt waveguide 133). In some examples, the composition and the thickness of the cladding layer may be configured such that the effective refractive index of the shunt waveguide 133 becomes closer to the refractive index of a bus waveguide to which the shunt waveguide 133 is optically coupled, when the optical switch is in the ON state. For example, the second waveguide region 118a may comprise a core region of the shunt waveguide 133, where the light is confined, and the cladding layer 500 can be a dielectric layer disposed on waveguide region 118a above the core region to adjust an effective refractive index of the shunt waveguide 133 (or the group velocity of the light propagating within the shunt waveguide 133), to improve the optical coupling between the shunt waveguide 133 and the corresponding bus waveguide (e.g., 132a, or 132b). In some examples, the cladding layer 500 may comprise one or more dielectric layers coated on the core region of the shunt waveguide 133. In some cases, a difference between the effective refractive index of the shunt waveguide 133 having the cladding layer 500 and that of the bus waveguide can be from 1% to 5% of the effective refractive index of the bus waveguide. In some examples, the effective index of a shunt waveguide having a tapered section (e.g., a tapered end region) may be determined based on a width of the shunt waveguide away from the tapered section. For example, the effective refractive index can be determined based on a longitudinal region of the shunt waveguide having the largest width.

FIG. 5C illustrates a side cross-sectional view of the optical switch 135 near one coupling end of the shunt waveguide 133 when the optical switch is in the OFF state (solid lines corresponding to FIG. 1B) and the ON state (dashed line corresponding to FIG. 1C). As shown in FIG. 5C, the clamping support structures 122 clamp a middle region of the optical switch 135 and the flexible support structures 120 allow the shunt waveguide 133 to move in the vertical direction (e.g., along x-axis) while providing an upward mechanical force (Fmech).

### Example Embodiments

Various additional example embodiments of the disclosure can be described by the following examples:

### Group I

Example 1. An optical switching cell, comprising:
a fixed waveguide layer fixed on a substrate, the fixed waveguide layer comprising:
a first bus optical waveguide extending between a first optical port and a second optical port; and
a second bus optical waveguide extending between a third optical port and a fourth optical port;
a suspended waveguide layer suspended over the fixed waveguide layer, the suspended waveguide layer vertically separated from the fixed waveguide layer and mechanically supported by a conductive clamping structure; and
the suspended waveguide layer comprising a shunt optical waveguide comprising silicon nitride or monocrystalline silicon and configured to redirect light from the first bus optical waveguide to the second optical bus waveguide,
wherein when electromechanically actuated, the shunt optical waveguide optically couples a first end region thereof to the first bus optical waveguide and a second end region thereof to the second bus optical waveguide to redirect the light.

Example 2. The optical switching cell of Example 1, wherein the conductive clamping structure clamps a longitudinal region of the shunt optical waveguide between the first and second end regions of the shunt optical waveguide, thereby defining a vertical distance between the fixed waveguide layer and the suspended waveguide layer.

Example 3. The optical switching cell of Example 2, wherein the conductive clamping structure comprises a lithographically defined metallic pillar formed over the fixed waveguide layer and vertically extending through the suspended waveguide layer.

Example 4. The optical switching cell of Example 3, wherein the metallic pillar is formed of aluminum or copper.

Example 5. The optical switching cell of Example 3 wherein the conductive clamping structure further comprises planar metallic layers connected to opposing ends of the metallic pillar.

Example 6. The optical switching cell of Example 3, wherein a space between the fixed waveguide layer and the suspended waveguide layer is substantially free of material other than the conductive clamping structure.

Example 7. The optical switching cell of Example 3, wherein the conductive clamping structure is not electrically connected to circuitry.

Example 8. The optical switching cell of Example 1, wherein the substrate comprises a silicon wafer having a silicon dioxide layer having the fixed waveguide layer formed thereover.

Example 9. The optical switching cell of Example 1, wherein the first bus optical waveguide comprises the silicon nitride that has been deposited over a sacrificial material that has been removed.

Example 10. The optical switching cell of Example 1, wherein the first bus optical waveguide comprises the monocrystalline silicon transferred from a silicon-on-insulator (SOI) substrate by flip-chip bonding.

Example 11. The optical switching cell of Example 1, wherein the first bus optical waveguide comprises a rib waveguide or a ridge waveguide.

Example 12. The optical switching cell of Example1, wherein the second bus optical waveguide comprises a rib waveguide or a ridge waveguide.

Example 13. The optical switching cell of Example 1, wherein the first and second bus optical waveguides are configured to support propagation of light having one of two orthogonal polarizations.

Example 14. The optical switching cell of Example 1, wherein the first and the second bus optical waveguides are configured to support propagation of light having transverse electric (TE) polarization with respect to the first and second bus optical waveguides.

Example 15. The optical switching cell of Example 1, wherein the suspended waveguide layer further comprises a suspended conductive region.

Example 16. The optical switching cell of Example 15, wherein the fixed waveguide layer further comprises a fixed conductive region.

Example 17. The optical switching cell of Example 16, wherein providing an electric potential difference between the suspended and fixed conductive regions causes a state of the shunt optical waveguide to change from an OFF state to an ON state.

Example 18. The optical switching cell of Example 17, wherein the suspended conductive region is configured to move at least one of the first and second end regions of the shunt optical waveguide along a vertical direction toward the substrate when the electric potential difference is provided between the suspended and fixed conductive regions.

Example 19. The optical switching cell of Example 15, wherein the suspended conductive region comprises a patterned metallic layer disposed on the suspended waveguide layer.

Example 20. The optical switching cell of Example 19, wherein the suspended conductive region is co-fabricated with the conductive clamping structure.

Example 21. The optical switching cell of Example 15, wherein the suspended conductive region comprises a doped portion the suspended waveguide layer.

Example 22. The optical switching cell of Example 16, wherein the fixed conductive region comprises a patterned metallic layer disposed on the fixed waveguide layer.

Example 23. The optical switching cell of Example 16, wherein the fixed conductive region comprises a doped portion the fixed waveguide layer.

Example 24. The optical switching cell of Example 19, wherein the patterned metallic layer comprises two conductive lines on opposite sides of the shunt optical waveguide.

Example 25. The optical switching cell of Example 1. wherein when the optical switching cell is actuated, the shunt optical waveguide is in an ON state and a vertical separation between the fixed waveguide layer and each of the first and second end regions is reduced.

Example 26. The optical switching cell of Example 25, wherein when the shunt optical waveguide is in the ON state, the first end region is optically coupled to the first bus optical waveguide and the second end region is optically coupled to the second bus optical waveguide such that more than 90% of optical power received from the first optical port is redirected to the fourth optical port.

Example 27. The optical switching cell of Example 26, wherein at least the first end region comprises a tapered region configured to adiabatically couple light between the first end region and the first bus optical waveguide, when the shunt optical waveguide is in the ON state.

Example 28. The optical switching cell of Example 2, wherein the suspended waveguide layer further comprises a flexible support structure configured to allow the first and second end regions to vertically move with respect to the substrate.

Example 29. The optical switching cell of Example 2, wherein the shunt optical waveguide comprises a core region and a cladding layer disposed on the core region, the cladding layer configured to match an effective refractive index of the shunt optical waveguide with those of the first and second bus optical waveguides.

### Group II

Example 1. A method of fabricating an optical switch, the method comprising:
providing a fixed waveguide layer comprising a first bus optical waveguide and a second bus optical waveguide fixed on a substrate;
forming a sacrificial layer on the fixed waveguide layer;
forming a suspended waveguide layer comprising monocrystalline silicon on the sacrificial layer;
forming a conductive clamping structure vertically separating the fixed waveguide layer and the suspended waveguide layer;
forming a shunt optical waveguide on the suspended waveguide layer configured to redirect light from the first bus optical waveguide to the second bus optical waveguide; and
removing the sacrificial layer such that the suspended waveguide layer is substantially mechanically supported over the fixed waveguide layer by the conductive clamping structure,
wherein when electromechanically actuated, the shunt optical waveguide optically couples a first end region thereof to the first bus optical waveguide and a second end region thereof to the second bus optical waveguide to redirect the light.

Example 2. The method of Example 1, wherein removing the sacrificial layer comprises removing by a dry etching process.

Example 3. The method of Example 2, wherein the sacrificial layer comprises an organic material, and removing the sacrificial layer comprises oxidizing the organic material.

Example 4. The method of Example 2, wherein the sacrificial layer comprises an inorganic material, and removing the sacrificial layer comprises selectively removing by reactive etching.

Example 5. The method of Example 2, wherein forming the conductive clamping structure comprises forming a vertical via through the suspended waveguide layer and further through the sacrificial layer and filling the vertical via.

Example 6. The method of Example 5, wherein forming the vertical via comprises lithographically patterning and etching through the suspended waveguide layer and the sacrificial layer.

Example 7. The method of Example 6, wherein filling the vertical via comprises depositing aluminum or copper.

Example 8. The method of Example 2, forming the suspended waveguide layer comprises transferring a monocrystalline silicon layer from a donor substrate by flip-chip bonding.

Example 9. The method of Example 8, wherein flip-chip bonding comprises:
providing a silicon-on-insulator (SOI) substrate having the monocrystalline silicon layer formed over a silicon substrate and separated therefrom by a buried oxide (BOX) layer;
contacting the monocrystalline silicon layer with the sacrificial layer to bond the monocrystalline silicon layer with the sacrificial layer; and removing the silicon substrate and the BOX layer.

Example 10. The method of Example 9, wherein bonding comprises direct thermal bonding without using an adhesive.

Example 11. The method of Example 9, wherein bonding comprises bonding without using an adhesive.

Example 12. The method of Example 1, wherein the substrate comprises a silicon wafer having a silicon dioxide layer having the fixed waveguide layer formed thereover.

Example 13. The method of Example 1, wherein the first bus optical waveguide comprises a rib waveguide or a ridge waveguide.

Example 14. The method of Example 1, wherein the second bus optical waveguide comprises a rib waveguide or a ridge waveguide.

Example 15. The method of Example 1, wherein the first and the second bus optical waveguides are configured to support propagation of light having one of two orthogonal polarizations.

Example 16. The method of Example 1, wherein the first and the second bus optical waveguides are configured to support propagation of light having transverse electric (TE) polarization with respect to the first and second bus optical waveguides.

Example 17. The method of Example 1, further comprising, before forming the sacrificial layer, forming a fixed conductive region on the fixed waveguide layer.

Example 18. The method of Example 17, further comprising, forming a suspended conductive region on the suspended waveguide layer.

Example 19. The method of Example 18, wherein providing an electric potential difference between the fixed and suspended conductive regions causes at least one of the first and second end regions to move to toward the substrate.

Example 20. The method of Example 17, wherein forming the fixed conductive region comprises disposing a first conductive layer on the fixed waveguide layer and lithographically patterning the first conductive layer.

Example 21. The method of Example 18. wherein forming the suspended conductive region comprises disposing a second conductive layer on the suspended waveguide layer and lithographically patterning the second conductive layer.

Example 22. The method of Example 17, wherein forming the fixed conductive region comprises doping the fixed waveguide layer.

Example 23. The method of Example 18, wherein forming the suspended conductive region comprises doping the suspended waveguide layer.

Example 24. The method of Example 1, wherein when the optical switch is in an ON state a vertical separation between the substrate and the first and second end regions is reduced.

Example 25. The method of Example 24, wherein when the shunt optical waveguide is in the ON state the first end region is optically coupled to the first bus optical waveguide and the second end region is optically coupled to the second bus optical waveguide such that more than 95% of optical power carried by an optical beam propagating in the first bus optical waveguide is transmitted to the second bus optical waveguide.

Example 26. The method of Example 25, wherein at least the first end region comprises a tapered region configured to adiabatically couple light between the first end region and the first bus optical waveguide, when the shunt optical waveguide is in the ON state.

Example 27. The method of Example 1, wherein forming the shunt optical waveguide comprises forming a flexible support structure configured to allow the first and second end regions to vertically move with respect to the substrate.

Example 28. The method of Example 21, wherein forming the conductive clamping structure comprises disposing the second conductive layer.

Example 29. The method of Example 1, wherein the conductive clamping structure comprises a conductive pillar extending from the fixed waveguide layer to the suspended waveguide layer.

Example 30. The method of Example 1, wherein the conductive clamping structure comprises copper or aluminum.

Example 31. The method of Example 1, wherein the sacrificial layer comprises a polymer.

Example 32. The method of Example 31, wherein the sacrificial layer comprises SU-8 or polyimide.

Example 33. The method of Example 1, further comprising disposing a dielectric layer on the suspended waveguide layer before lithographically forming the shunt optical waveguide.

Example 34. The method of Example 33, wherein forming the shunt optical waveguide comprises forming an index matching layer on the shunt optical waveguide, the index matching layer configured to match an effective index of the shunt optical waveguide with an effective index of the first and second bus optical waveguides.

### Group III

Example 1. A method of fabricating an optical switch, the method comprising:
providing a fixed waveguide layer comprising a first bus optical waveguide and a second bus optical waveguide fixed on a substrate;
forming a sacrificial layer on the fixed waveguide layer;
forming a suspended waveguide layer comprising silicon nitride on the sacrificial layer;
forming a conductive clamping structure vertically separating the fixed waveguide layer and the suspended waveguide layer;
forming a shunt optical waveguide on the suspended waveguide layer configured to redirect light from the first bus optical waveguide to the second bus optical waveguide; and
removing the sacrificial layer such that the suspended waveguide layer is substantially mechanically supported over the fixed waveguide layer by the conductive clamping structure,
wherein when electromechanically actuated, the shunt optical waveguide optically couples a first end region thereof to the first bus optical waveguide and a second end region thereof to the second bus optical waveguide to redirect the light.

Example 2. The method of Example 1, wherein removing the sacrificial layer comprises removing by a dry etching process.

Example 3. The method of Example 2, wherein the sacrificial layer comprises an organic material, and removing the sacrificial layer comprises oxidizing the organic material.

Example 4. The method of Example 2, wherein the sacrificial layer comprises an inorganic material, and removing the sacrificial layer comprises selectively removing by reactive etching.

Example 5. The method of Example 2, wherein forming the conductive clamping structure comprises forming a vertical via through the suspended waveguide layer and further through the sacrificial layer and filling the vertical via.

Example 6. The method of Example 5, wherein forming the vertical via comprises lithographically patterning and etching through the suspended waveguide layer and the sacrificial layer.

Example 7. The method of Example 6, wherein filling the vertical via comprises depositing aluminum or copper.

Example 8. The method of Example 6, wherein the first and second bus optical waveguides comprise silicon nitride.

Example 9. The method of Example 1, wherein forming the suspended waveguide layer comprises disposing a silicon nitride layer using chemical vapor deposition (CVD), plasma enhanced chemical vapor deposition (PECVD), or low-pressure chemical vapor deposition (LPCVD).

Example 10. The method of Example 1, wherein the substrate comprises a silicon wafer having a silicon dioxide layer having the fixed waveguide layer formed thereover.

Example 11. The method of Example 1, wherein the first bus optical waveguide comprises a rib waveguide or a ridge waveguide.

Example 12. The method of Example 1, wherein the second bus optical waveguide comprises a rib waveguide or a ridge waveguide.

Example 13. The method of Example 1, wherein the first and the second bus optical waveguides are configured to support propagation of light having one of two orthogonal polarizations.

Example 14. The method of Example 1, wherein the first and the second bus optical waveguides are configured to support propagation of light having transverse electric (TE) polarization with respect to the first and second bus optical waveguides.

Example 15. The method of Example 1, further comprising, before forming the sacrificial layer, forming a fixed conductive region on the fixed waveguide layer.

Example 16. The method of Example 15, further comprising, forming a suspended conductive region on the suspended waveguide layer.

Example 17. The method of Example 16, wherein providing an electric potential difference between the fixed and suspended conductive regions causes at least one of the first and the second end regions to move to toward the substrate.

Example 18. The method of Example 15, wherein forming the fixed conductive region comprises disposing a first conductive layer on the fixed waveguide layer and lithographically patterning the first conductive layer.

Example 19. The method of Example 16, wherein forming the suspended conductive region comprises disposing a second conductive layer on the suspended waveguide layer and lithographically patterning the second conductive layer.

Example 20. The method of Example 1, wherein when the optical switch is in an ON state the vertical separation between the substrate and the first and second end regions is reduced.

Example 21. The method of Example 20, wherein when the shunt optical waveguide is in the ON state the first end region is optically coupled to the first bus optical waveguide and the second end region is optically coupled to the second bus optical waveguide such that more than 95% of optical power carried by an optical beam propagating in the first bus optical waveguide is transmitted to the second bus optical waveguide.

Example 22. The method of Example 21, wherein at least the first end region comprises a tapered region configured to adiabatically couple light between the first end region and the first bus optical waveguide, when the shunt optical waveguide is in the ON state.

Example 23. The method of Example 1, wherein forming the shunt optical waveguide comprises forming a flexible support structure configured to allow the first and the second end regions to vertically move with respect to the substrate.

Example 24. The method of Example 19. wherein forming the conductive clamping structure comprises disposing the second conductive layer.

Example 25. The method of Example 1, wherein the conductive clamping structure comprises a conductive pillar extending from the fixed waveguide layer to the suspended waveguide layer.

Example 26. The method of Example 1, wherein the conductive clamping structure comprises copper or aluminum.

Example 27. The method of Example 1, wherein the sacrificial layer comprises a polymer.

Example 28. The method of Example 1, wherein the sacrificial layer comprises SU-8 or polyimide.

Example 29. The method of Example 1, further comprising disposing a dielectric layer on the suspended waveguide layer before lithographically forming the shunt optical waveguide.

Example 30. The method of Example 29, wherein forming the shunt optical waveguide comprises forming an index matching layer on the shunt optical waveguide, the index matching layer configured to match an effective index of the shunt optical waveguide with an effective index of the first and second bus optical waveguides.

### Additional Considerations

As for additional details pertinent to the present invention, materials and manufacturing techniques may be employed as within the level of those with skill in the relevant art. The same may hold true with respect to method-based aspects of the invention in terms of additional acts commonly or logically employed. Also, it is contemplated that any optional feature of the inventive variations described may be set forth and claimed independently, or in combination with any one or more of the features described herein. Likewise, reference to a singular item, includes the possibility that there are plural of the same items present. More specifically, as used herein and in the appended claims, the singular forms “a,” “and,” “said,” and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Unless defined otherwise herein, all technical and scientific terms used herein have the same meaning as commonly understood by one of ordinary skill in the art to which this invention belongs. The breadth of the present invention is not to be limited by the subject specification, but rather only by the plain meaning of the claim terms employed.

In the embodiments described above, apparatus, systems, and methods for sensing electrical overstress events are described in connection with particular embodiments. It will be understood, however, that the principles and advantages of the embodiments can be used for any other systems, apparatus, or methods with a need for sensing and/or protecting against electrical overstress events.

The principles and advantages described herein can be implemented in various apparatuses. Examples of such apparatuses can include, but are not limited to, consumer electronic products, parts of the consumer electronic products, electronic test equipment, etc. Examples of parts of consumer electronic products can include clocking circuits, analog to digital converts, amplifiers, rectifiers, programmable filters, attenuators, variable frequency circuits, etc. Examples of the electronic devices can also include memory chips, memory modules, circuits of optical networks or other communication networks, and disk driver circuits. Consumer electronic products can include, but are not limited to, wireless devices, a mobile phone (for example, a smart phone), cellular base stations, a telephone, a television, a computer monitor, a computer, a hand-held computer, a tablet computer, a laptop computer, a personal digital assistant (PDA), a microwave, a refrigerator, a stereo system, a cassette recorder or player, a DVD player, a CD player, a digital video recorder (DVR), a VCR, an MP3 player, a radio, a camcorder, a camera, a digital camera, a portable memory chip, a washer, a dryer, a washer/dryer, a copier, a facsimile machine, a scanner, a wrist watch, a smart watch, a clock, a wearable health monitoring device, etc. Further, apparatuses can include unfinished products.

Unless the context clearly requires otherwise, throughout the description and the claims, the words “comprise,” “comprising,” “include,” “including,” and the like are to be construed in an inclusive sense, as opposed to an exclusive or exhaustive sense; that is to say, in the sense of “including, but not limited to.” The words “coupled” or connected”, as generally used herein, refer to two or more elements that may be either directly connected, or connected by way of one or more intermediate elements. Additionally, the words “herein,” “above,” “below.” and words of similar import, when used in this application, shall refer to this application as a whole and not to any particular portions of this application. Where the context permits, words in the Detailed Description using the singular or plural number may also include the plural or singular number, respectively. The words “or” in reference to a list of two or more items, is intended to cover all of the following interpretations of the word: any of the items in the list, all of the items in the list, and any combination of the items in the list. All numerical values provided herein are intended to include similar values within a measurement error.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states.

The teachings of the inventions provided herein can be applied to other systems, not necessarily the systems described above. The elements and acts of the various embodiments described above can be combined to provide further embodiments. The acts of the methods discussed herein can be performed in any order as appropriate. Moreover, the acts of the methods discussed herein can be performed serially or in parallel, as appropriate.

While certain embodiments of the inventions have been described, these embodiments have been presented by way of example only, and are not intended to limit the scope of the disclosure. Indeed, the novel methods and systems described herein may be embodied in a variety of other forms. Furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure. Accordingly, the scope of the present inventions is defined by reference to the claims.

1. An optical switching cell, comprising:
a fixed waveguide layer fixed on a substrate, the fixed waveguide layer comprising:
a first bus optical waveguide extending between a first optical port and a second optical port; and
a second bus optical waveguide extending between a third optical port and a fourth optical port;
a suspended waveguide layer suspended over the fixed waveguide layer, the suspended waveguide layer vertically separated from the fixed waveguide layer and mechanically supported by a conductive clamping structure; and
the suspended waveguide layer comprising a shunt optical waveguide comprising silicon nitride or monocrystalline silicon and configured to redirect light from the first bus optical waveguide to the second optical bus waveguide,
wherein when electromechanically actuated, the shunt optical waveguide optically couples a first end region thereof to the first bus optical waveguide and a second end region thereof to the second bus optical waveguide to redirect the light.

2. The optical switching cell of claim 1, wherein the conductive clamping structure clamps a longitudinal region of the shunt optical waveguide between the first and second end regions of the shunt optical waveguide, thereby defining a vertical distance between the fixed waveguide layer and the suspended waveguide layer.

3. The optical switching cell of claim 1, wherein the conductive clamping structure comprises a lithographically defined metallic pillar formed over the fixed waveguide layer and vertically extending through the suspended waveguide layer.

4. The optical switching cell of claim 3, wherein the conductive clamping structure further comprises planar metallic layers connected to opposing ends of the metallic pillar.

5. The optical switching cell of claim 3, wherein the conductive clamping structure is not electrically connected to circuitry.

6. The optical switching cell of claim 1, wherein the first bus optical waveguide comprises the silicon nitride that has been deposited over a sacrificial material that has been removed.

7. The optical switching cell of claim 1, wherein the first bus optical waveguide comprises the monocrystalline silicon transferred from a silicon-on-insulator (SOI) substrate by flip-chip bonding.

8. The optical switching cell of claim 1, wherein the suspended waveguide layer further comprises a suspended conductive region.

9. The optical switching cell of claim 8, wherein the suspended conductive region is co-fabricated with the conductive clamping structure.

10. The optical switching cell of claim 1, wherein when the optical switching cell is actuated the first end region is optically coupled to the first bus optical waveguide and the second end region is optically coupled to the second bus optical waveguide such that more than 90% of optical power received from the first optical port is redirected to the fourth optical port.

11. A method of fabricating an optical switch, the method comprising:
providing a fixed waveguide layer comprising a first bus optical waveguide and a second bus optical waveguide fixed on a substrate;
forming a sacrificial layer on the fixed waveguide layer;
forming a suspended waveguide layer comprising monocrystalline silicon on the sacrificial layer;
forming a conductive clamping structure vertically separating the fixed waveguide layer and the suspended waveguide layer;
forming a shunt optical waveguide on the suspended waveguide layer configured to redirect light from the first bus optical waveguide to the second bus optical waveguide; and
removing the sacrificial layer such that the suspended waveguide layer is substantially mechanically supported over the fixed waveguide layer by the conductive clamping structure,
wherein when electromechanically actuated, the shunt optical waveguide optically couples a first end region thereof to the first bus optical waveguide and a second end region thereof to the second bus optical waveguide to redirect the light.

12. The method of claim 11, wherein removing the sacrificial layer comprises removing by a dry etching process.

13. The method of claim 11, wherein forming the conductive clamping structure comprises forming a vertical via through the suspended waveguide layer and further through the sacrificial layer and filling the vertical via.

14. The method of claim 11, wherein forming the suspended waveguide layer comprises transferring a monocrystalline silicon layer from a donor substrate by flip-chip bonding.

15. The method of claim 14, wherein flip-chip bonding comprises:
providing a silicon-on-insulator (SOI) substrate having the monocrystalline silicon layer formed over a silicon substrate and separated therefrom by a buried oxide (BOX) layer;
contacting the monocrystalline silicon layer with the sacrificial layer to bond the monocrystalline silicon layer with the sacrificial layer; and
removing the silicon substrate and the BOX layer.

16. The method of claim 11, further comprising forming an index matching layer on the shunt optical waveguide, the index matching layer configured to match an effective index of the shunt optical waveguide with an effective index of the first and second bus optical waveguides.

17. A method of fabricating an optical switch, the method comprising:
providing a fixed waveguide layer comprising a first bus optical waveguide and a second bus optical waveguide fixed on a substrate;
forming a sacrificial layer on the fixed waveguide layer;
forming a suspended waveguide layer comprising silicon nitride on the sacrificial layer;
forming a conductive clamping structure vertically separating the fixed waveguide layer and the suspended waveguide layer;
forming a shunt optical waveguide on the suspended waveguide layer configured to redirect light from the first bus optical waveguide to the second bus optical waveguide; and
removing the sacrificial layer such that the suspended waveguide layer is substantially mechanically supported over the fixed waveguide layer by the conductive clamping structure,
wherein when electromechanically actuated, the shunt optical waveguide optically couples a first end region thereof to the first bus optical waveguide and a second end region thereof to the second bus optical waveguide to redirect the light.

18. The method of claim 17, wherein the sacrificial layer comprises an organic material, and removing the sacrificial layer comprises oxidizing the organic material.

19. The method of claim 17, wherein forming the conductive clamping structure comprises lithographically patterning and etching through the suspended waveguide layer and the sacrificial layer.

20. The method of claim 17, wherein forming the conductive clamping structure comprises forming a conductive region on the suspended waveguide layer.
